(19) United States
(12) Patent Application Publication
(10) Pub. No.: US 2018/0347860 A1
(43) Pub. Date: Dec. 6, 2018

(54) HEAT SOURCE MACHINE AND OPERATING METHOD THEREFOR

(71) Applicants: MITSUBISHI HEAVY INDUSTRIES THERMAL SYSTEMS, LTD., Tokyo (JP); CENTRAL GLASS COMPANY, LIMITED., Ube-shi, Yamaguchi (JP)

(72) Inventors: Kazuki WAJIMA, Tokyo (JP); Noriyuki MATSUKURA, Tokyo (JP); Kenji UEDA, Tokyo (JP); Naoki KOBAYASHI, Tokyo (JP); Ryosuke SUEMITSU, Tokyo (JP); Yoshinori AKAMATSU, Tokyo (JP); Fuyuhiko SAKYU, Kawagoe-shi (JP); Kanako OSAFUNE, Kawagoe-shi (JP); Masanori TAMURA, Tsukuba-shi (JP); Hiroyuki SUDA, Tsukuba-shi (JP); Junji MIZUKADO, Tsukuba-shi (JP); Kenji TAKIZAWA, Tsukuba-shi (JP); Liang CHEN, Tsukuba-shi (JP); Heng-dao QUAN, Tsukuba-shi (JP)

(73) Assignees: MITSUBISHI HEAVY INDUSTRIES THERMAL SYSTEMS, LTD., Tokyo (JP); CENTRAL GLASS COMPANY, LIMITED., Ube-shi, Yamaguchi (JP)

(21) Appl. No.: 15/780,844

(22) PCT Filed: Feb. 9, 2017
(86) PCT No.: PCT/JP2017/004755

§ 371 Date: Jun. 1, 2018

(30) Foreign Application Priority Data
Feb. 10, 2016 (JP) 2016-023803

(51) Int. Cl. F25B 1/053; C09K 5/04

(52) U.S. Cl. CPC F25B 1/053; F25B 30/02; C09K 5/045

(57) ABSTRACT

An object of the present invention is to provide a heat source machine that can reduce the environmental load and can output the thermal energy with high temperature, and a method for operating the heat source machine. A heat source machine of the present invention includes a centrifugal compressor, condensers, expansion valves, and an evaporator, in which a refrigerant enclosed in a refrigerant circulation circuit configured by sequentially connecting the centrifugal compressor, the condensers, the expansion valves, and the evaporator contains a composition A, a composition B, or a composition C, the composition A has 4 or 5 carbon atoms, 6 or more fluorine atoms, and one or more oxygen atoms, the composition B has 4 or 5 carbon atoms and 6 or more fluorine atoms, the composition C has 3 carbon atoms, 2 chlorine atoms, 3 fluorine atoms, and an intramolecular double bond, and the composition A, the composition B, or the composition C has a boiling point of 20° C. or more and a critical temperature of 180° C. or more.

### TECHNICAL FIELD

The present invention relates to a heat source machine, and a method for operating the heat source machine.

### BACKGROUND ART

As a method for supplying thermal energy, it is known to use a heat pump (heat source machine). The heat pump can reduce the amount of carbon dioxide (CO₂) emission per heating capacity as compared with a conventional boiler.

In a heat pump, hydrofluorocarbon (HFC), hydrochlorofluorocarbon (HCFC), or the like is used as a heat operating medium (refrigerant). In HFC, there are R134a, R410A, R245fa, R32, and the like. In HCFC, there are R123, and the like.

The HFC and the HCFC each have a high global warming potential (GWP). For example, GWPs of R134a, R410A, R245fa, and R32 are 1300, 1923, 858, and 677, respectively (see IPCC 5th). For example, R123 has a GWP of 79, but the ozone-depleting potential (ODP) is 0.33, and thus the R123 is a substance subject to the elimination in the Treaty of Montreal. The use of a refrigerant with a high GWP or the use of a refrigerant that destroys the ozone layer is undesirable from the viewpoint of the environmental load. Patent Literature 1 describes a heat medium having a low load on the environment.

### CITATION LIST

### Patent Literature

### {PTL 1}

Japanese Unexamined Patent Application, Publication No. 2014-5419 A (paragraph {0028})

### SUMMARY OF INVENTION

### Technical Problem

Currently, as a substitute for a boiler for domestic use, for business use, or the like, a heat pump which has small capacity and supplies thermal energy (100° C. or less) with relatively low temperature has been put into practical use. However, a heat pump in an industrial field, which has large capacity and is required to withstand the use at high temperature (exceeding 100° C.), has not been spread. In particular, a heat pump that supplies thermal energy with high temperature exceeding 150° C. has not been put into practical use. Therefore, realization of a heat pump that can output thermal energy with high temperature has been demanded.

In a heat pump that outputs thermal energy with high temperature, the temperature of a refrigerant also becomes high. When the refrigerant reaches a high temperature, there is a problem such that: (1) the refrigerant is easily isomerized or decomposed; (2) the pressure of the refrigerant becomes high; and high pressure resistance is required for a functional component such as a valve used for a heat pump, and (3) in a case where a waste heat recovery type heat pump with large capacity is used, it is required to secure higher safety because a pressure vessel with high pressure and large capacity is installed.

In a heat pump for heating or hot water supply for domestic use, a natural refrigerant or a refrigerant of an organic compound is used. The natural refrigerant is CO₂. The refrigerant of an organic compound is R410A, R32, or the like. The normal boiling point of CO₂ and the critical temperature of CO₂ are −78.5° C., and 31.05° C., respectively. The normal boiling point of R410A and the critical temperature of R410A are −48.5° C., and 72.5° C., respectively. The normal boiling point of R32 and the critical temperature of R32 are −51.65° C., and 78.105° C. respectively. For all of these three refrigerants, the pressure becomes high during the operation of a heat pump at high temperature, and therefore, the application to a heat pump with large capacity is not realistic.

In a heat pump for the application of air conditioning, or the like, R123, R245fa, R1234yf, or R1234ze(E), or the like is used. The normal boiling point of R123 and the critical temperature of R123 are 27.7° C., and 81.5° C., respectively. The normal boiling point of R245fa and the critical temperature of R245fa are 15.3° C., and 154° C., respectively. As described above, R123 and R245fa are low-pressure refrigerants. However, R123 has a low GWP, but the ozone-depleting potential (ODP) is 0.33, and the R123 is a substance subject to the elimination in the Treaty of Montreal. R245fa has an ODP of 0, but the GWP is high. R1234yf and R1234ze(E) each have a low GWP (0 or 1), and a low load on the environment, but have high pressure under a high temperature condition.

The present invention has been made in view of such circumstances, and an object of the present invention is to provide a heat source machine that can reduce the environmental load and output the thermal energy with high temperature, and a method for operating the heat source machine.

### Solution to Problem

In order to solve the problem described above, a heat source machine and a method for operating the heat source machine of the present invention employ the following solution. The present invention is to provide a heat source machine including: a centrifugal compressor for compressing a refrigerant; a condenser for condensing the compressed refrigerant; an expansion valve for expanding the condensed refrigerant; and an evaporator for evaporating the expanded refrigerant, in which a refrigerant enclosed in a refrigerant circulation circuit configured by sequentially connecting the centrifugal compressor, the condenser, the expansion valve, and the evaporator contains a composition A, a composition B, or a composition C, the composition A has 4 or 5 carbon atoms, 6 or more fluorine atoms, and one or more oxygen atoms, the composition B has 4 or 5 carbon atoms and 6 or more fluorine atoms, the composition C has 3 carbon atoms, 2 chlorine atoms, 3 fluorine atoms, and an intramolecular double bond, and the composition A, the composition B, or the composition C has a boiling point of 20° C. or more and a critical temperature of 180° C. or more.

According to one aspect of the present invention, the composition A may be a composition containing 6 fluorine atoms and a methoxy group. The composition A may be 2,2,2,2′,2′,2′-hexafluoroisopropyl-methyl-ether.

According to one aspect of the present invention, the composition B may be a composition containing 6 fluorine atoms and a cyclic structure having 5 carbon atoms, or a composition containing 8 fluorine atoms, 5 carbon atoms, and an intramolecular double bond. The composition B may be 3,3,4,4,5,5-hexafluorocyclopentene, 1,1,2,2,3,3-hexafluorocyclopentane, (E)-1,1,1,4,4,5,5,5-octafluoro-2-pentene, or (Z)-1,1,1,4,4,5,5,5-octafluoro-2-pentene.

According to one aspect of the present invention, the composition C may be 1,2-dichloro-3,3,3-trifluoropropene.

According to the present invention, there is provided a method for operating a heat source machine, wherein the heat source machine includes: a centrifugal compressor for compressing a refrigerant; a condenser for condensing the compressed refrigerant; an expansion valve for expanding the condensed refrigerant; an evaporator for evaporating the expanded refrigerant; and a refrigerant circulation circuit configured by sequentially connecting the centrifugal compressor, the condenser, the expansion valve, and the evaporator, the refrigerant is selected from any one of: a composition A having 4 or 5 carbon atoms, 6 or more fluorine atoms, and one or more oxygen atoms; a composition B having 4 or 5 carbon atoms and 6 or more fluorine atoms; and a composition C having 3 carbon atoms, 2 chlorine atoms, 3 fluorine atoms, and an intramolecular double bond, and is enclosed in the refrigerant circulation circuit, the composition A, the composition B, or the composition C having a boiling point of 20° C. or more and a critical temperature of 180° C. or more.

According to one aspect of the present invention, heat is recovered in the evaporator, and thermal energy with 150° C. or more is output by the recovered heat in the condenser.

### Advantageous Effects of Invention

According to one aspect of the present invention, by setting the boiling point of a refrigerant and the critical temperature of a refrigerant within the respective ranges described above, the refrigerant pressure under the environment of the operation at high temperature can be lower than that of a conventional refrigerant. As a result, thermal energy exceeding 150° C. can be output with a refrigerant pressure similar to that of a conventional heat source machine.

According to one aspect of the present invention, by using a centrifugal-type compressor, the coefficient of performance can be improved. This can avoid increasing the size of the heat source machine, even when a refrigerant having a low pressure is used.

A composition A and a composition B each exhibit stable properties even in a high temperature environment of 150° C. or more. By using a refrigerant containing a composition A and a composition B, a heat source machine can operate stably for a long period of time.

2,2,2,2′,2′,2′-Hexafluoroisopropyl-methyl-ether, 3,3,4,4,5,5-hexafluorocyclopentene, 1,1,2,2,3,3-hexafluorocyclopentane, (E)-1,1,1,4,4,5,5,5-octafluoro-2-pentene, (Z)-1,1,1,4,4,5,5,5-octafluoro-2-pentene, and 1,2-dichloro-3,3,3-trifluoropropene each are a composition having a small GWP. By using such a composition as a refrigerant, a heat source machine with low environmental load can be realized.

### BRIEF DESCRIPTION OF DRAWINGS

FIG. 1 is a diagram of a heat pump cycle of the heat source machine according to one embodiment of the present invention.

### DESCRIPTION OF EMBODIMENTS

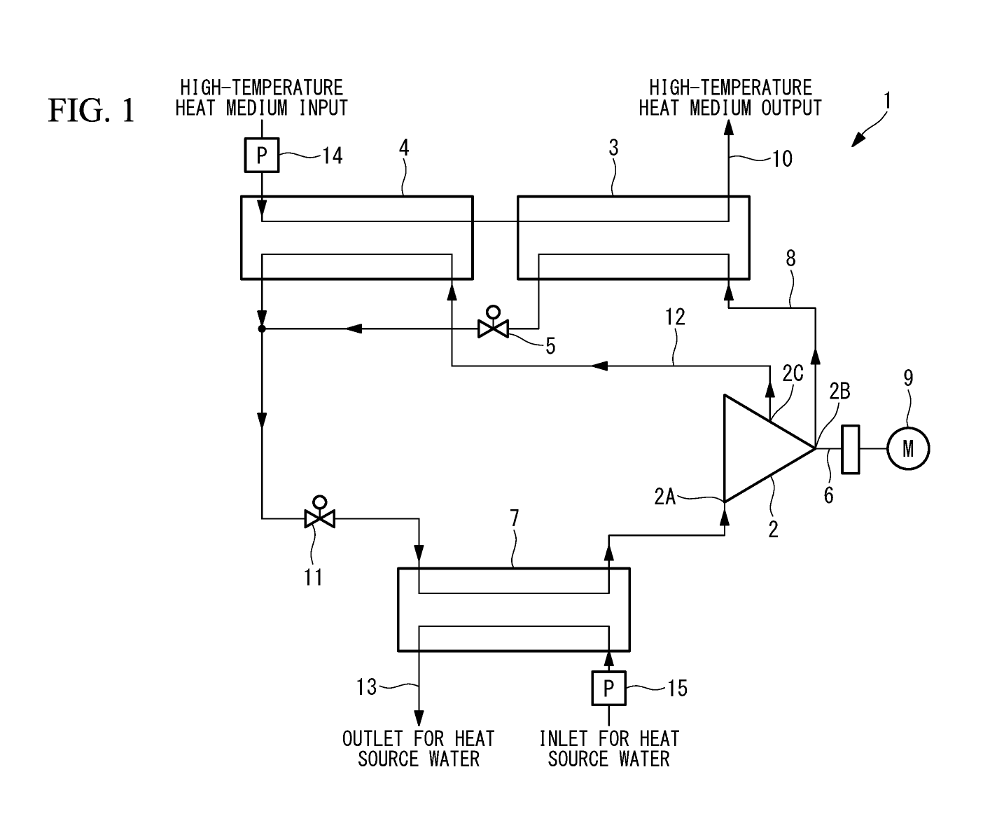

Hereinafter, one embodiment of the heat source machine and operating method therefor according to the present invention will be described while making reference to the drawing. FIG. 1 is a diagram of a heat pump cycle of the heat source machine according to the present embodiment.

A heat source machine 1 is provided with a centrifugal compressor 2, a high-temperature condenser 3 for heating a heat medium with a refrigerant gas having high pressure and high temperature, a medium-temperature condenser 4 for heating a heat medium with a refrigerant gas having medium pressure and medium temperature, a high-pressure stage expansion valve 5, a low-pressure stage expansion valve 11, an evaporator 7, and a control device (not shown). The heat source machine 1 is provided with a refrigerant circulation circuit (heat pump cycle) 8 configured by sequentially connecting the centrifugal compressor 2, the high-temperature condenser 3, the medium-temperature condenser 4, the high-pressure stage expansion valve 5, the low-pressure stage expansion valve 11, and the evaporator 7 with a pipe. In the heat pump cycle, a refrigerant is enclosed.

The centrifugal compressor 2 is a device that compresses a refrigerant in one stage or in multiple stages. In the present embodiment, the centrifugal compressor 2 is a two-stage turbo compressor. By using a centrifugal-type compressor and using a regenerative cycle that heats a heat medium in a cascade manner, a coefficient of performance (COP) of 3 or more for the heat source machine 1 can be obtained. For the shape of the centrifugal compressor 2, an open impeller by machining is used. The material for the centrifugal compressor 2 is an aluminum alloy (A6061, A7075, or A2618) or iron (SCM 435) (SCM is an abbreviation of chromium molybdenum steel).

The flow coefficient of the centrifugal compressor 2 is set to 0.1 or more. In an ordinary compressor, the flow coefficient is set to about 0.08 as the design point. However, in a case where a refrigerant with a low pressure is used, the specific volume of the refrigerant is large, and therefore, the size of the impeller becomes large in order to obtain the heating capacity. By setting the flow coefficient of the centrifugal compressor 2 to 0.1 or more, the increase in size of the heat source machine 1 can be suppressed.

The centrifugal compressor 2 is driven by an electric motor 9 via a rotating shaft 6.

The electric motor 9 is driven by, for example, an inverter. The electric motor 9 is provided with a structure for cooling the electric motor 9 (not shown). In the structure for cooling, a refrigerant obtained by decompressing and expanding the refrigerant that has been condensed and liquefied in a high-temperature condenser 3 as described later is passed through between a stator side face and a coil part in the electric motor 9 and further between a stator and a rotor in the electric motor 9 to cool the electric motor 9.

The rotating shaft 6 is supported by a rolling bearing, a roller bearing, a slide bearing, or a magnetic bearing. According to this, the mechanical loss can be reduced. The rotating shaft 6 is directly connected to the electric motor 9 or is connected to the electric motor 9 via a speed increasing gear.

The bearing and the speed increasing gear can be cooled and lubricated by circulating a lubricating oil. The lubricating oil is preferably a mineral oil, a polyol ester or alkylbenzene oil, or the like, which is compatible with a refrigerant.

The centrifugal compressor 2 is provided with a suction opening 2A, a discharge opening 2B, and an intermediate discharge opening 2C arranged between a first impeller and a second impeller, which are not shown. The centrifugal compressor 2 is configured so as to sequentially centrifugally compress a low-pressure gas refrigerant sucked from the suction opening 2A by the rotation of the first impeller and the second impeller, and to discharge the compressed high-pressure gas refrigerant from the discharge opening 2B. Part of the intermediate-pressure gas refrigerant compressed by the first-stage impeller is discharged from the intermediate discharge opening 2C. In front of the first impeller and the second impeller, suction vanes are attached, respectively (not shown). By adjusting the degree of opening of the suction vane, the amount of air sucked into the centrifugal compressor 2 is controlled.

The high-pressure gas refrigerant discharged from the discharge opening 2B of the centrifugal compressor 2 is led into the high-temperature condenser 3.

The medium-pressure gas refrigerant discharged from the intermediate discharge opening 2C of the centrifugal compressor 2 is led into the medium-temperature condenser 4 via an intermediate discharge circuit 12.

The high-temperature condenser 3 and the medium-temperature condenser 4 each are a plate-type heat exchanger, and condense and liquefy the high-pressure refrigerant gas and the intermediate-pressure refrigerant gas by performing, in a stepwise manner, heat exchange of the high-pressure gas refrigerant and the intermediate-pressure gas refrigerant, which are supplied from the centrifugal compressor 2, with a heat medium (first non-refrigerant) that circulates via a hot water circuit 10. The heat medium is heated from the temperature of about 70° C. to the intermediate temperature of 100° C. or more in the medium-temperature condenser 4, and the high-temperature condenser 3 can generate thermal energy with 150° C. or more, preferably 200° C. or more. It is desired that the flow of the high-temperature heat medium supplied by the high-temperature heat medium pump (first non-refrigerant pump) 14 and the flow of the high-pressure gas refrigerant run counter to each other. The number of the plate-type heat exchangers is not limited to one, and multiple plate-type heat exchangers may be arranged.

On a rear flow side of the high-temperature condenser 3, there is a heat exchanger (not shown) in which a liquid refrigerant obtained by condensation and liquefaction in the high-temperature condenser 3 is decompressed and expanded, and heat exchange with a lubricating oil is performed. The refrigerant, which is decompressed and expanded, is led into a passage on one side across the heat transfer face of the heat exchanger, and the lubricating oil is led into a passage on the other side. In this way, the lubricating oil is cooled by the refrigerant, which is decompressed and expanded.

The liquid refrigerant obtained by condensation and liquefaction in the high-temperature condenser 3 is decompressed and expanded by passing through the high-pressure stage expansion valve 5, and merges with a liquid refrigerant obtained by condensation and liquefaction in the medium-temperature condenser 4. By passing through a low-pressure stage expansion valve 11, the merged liquid refrigerant is decompressed and expanded, and supplied to an evaporator 7. In order to further improve the heating performance, heat exchange of the liquid refrigerant after merging with a heat medium before entering the medium-temperature condenser 4 may be performed to preheat the heat medium (not shown).

The evaporator 7 is a plate-type heat exchanger, and by performing heat exchange of the refrigerant led from the low-pressure stage expansion valve 11 with the heat source water (second non-refrigerant) that circulates via a heat source water circuit 13, the refrigerant is evaporated, and the heat source water is cooled by the latent heat of the evaporation. It is desired that the flow of the heat source water supplied by a heat source water pump (second non-refrigerant pump) 15 and the flow of the refrigerant run counter to each other.

The high-pressure stage expansion valve 5 and the low-pressure stage expansion valve 11 each are a fixed orifice, an electric ball valve, or a stepping motor type needle valve.

A control device that is not shown is provided with a microcomputer board. The degree of the opening of each suction vane, the degree of the opening of each expansion valve, and the number of rotations of the electric motor are calculated and controlled by a microcomputer board of the control device. As a result, high COP can be achieved even in partial load operation.

In a case where the centrifugal compressor 2 is a multistage compressor, the heat source machine 1 may adopt a natural expansion type economizer cycle in which all of the liquid refrigerant liquefied in the condensers is decompressed and expanded by a high-pressure expansion valve, the vaporized gas refrigerant (intermediate pressure refrigerant) is led to an intermediate suction opening of a compressor, and the separated liquid refrigerant is again decompressed and expanded by a low-pressure stage expansion valve, and supplied to an evaporator; or the heat source machine 1 may adopt an intermediate cooling type economizer cycle in which part of the liquid refrigerant liquefied in a high-temperature condenser is branched, and decompressed and expanded, and then heat-exchanged with a refrigerant liquid flowing through the main circuit, a gas refrigerant (intermediate pressure refrigerant) evaporated by excessively cooling the liquid refrigerant of the main circuit is led to an intermediate suction opening of a compressor, and the excessively-cooled liquid refrigerant of the main circuit is decompressed and expanded, and supplied to an evaporator. The heat source machine 1 may be provided with an intercooler for heating the sucked refrigerant gas of the centrifugal compressor 2 (not shown). According to this, the temperature of the gas refrigerant discharged from the compressor is increased, and thermal energy with a higher temperature can be supplied.

The refrigerant placed (enclosed) in a heat pump cycle 8 contains a composition A, a composition B, or a composition C as the main component. It is preferred that the composition A, the composition B, or the composition C is contained in a refrigerant (100 GC %) in an amount of more than 50 GC %, preferably more than 75 GC %, and more preferably more than 90 GC %.

The composition A, the composition B, or the composition C is an organic compound. The composition A, the composition B, or the composition C has a boiling point of 20° C. or more, and further has a critical temperature of 180° C. or more. The composition A, the composition B, or the composition C has a nature that the pressure under an operating environment of a heat source machine becomes 5 MPa or less. The GWP of the composition A, the composition B, or the composition C is 150 or less. The ozone depleting potential (ODP) of the composition A, the composition B, or the composition C is approximately zero. The approximately zero means any numerical value as long as it is not subject to regulation, including values less than 0.005. The purity of the composition A, the composition B, or the composition C is preferably 97 GC % or more, more preferably 99 GC % or more, and furthermore preferably 99.9 GC % or more.

The composition A contains 4 or 5 carbon atoms, 6 or more fluorine atoms, and one or more oxygen atoms. Preferably, the composition A is a composition containing 6 fluorine atoms and a methoxy group. Specifically, the composition A is 2,2,2,2′,2′,2′-hexafluoroisopropyl-methyl-ether (HFE-356mmz, C₄H₄OF₆), or the like. The normal boiling point (boiling point at atmospheric pressure) of HFE-356mmz is 50° C. The critical temperature of HFE-356mmz is 186° C. The global warming potential (GWP) of HFE-356mmz is 25.

The composition B contains 4 or 5 carbon atoms and 6 or more fluorine atoms. Preferably, the composition B is a composition B1 containing 6 fluorine atoms and a cyclic structure having 5 carbon atoms, or a composition B2 containing 8 fluorine atoms, 5 carbon atoms, and an intramolecular double bond.

Specifically, the composition B1 is 3,3,4,4,5,5-hexafluorocyclopentene (3,3,4,4,5,5-HFCPE, C₅H₂F₆), 1,1,2,2,3,3-hexafluorocyclopentane (1,1,2,2,3,3-HFCPA, C₅H₄F₆), or the like. The normal boiling point of 3,3,4,4,5,5-HFCPE is 68° C. The critical temperature of 3,3,4,4,5,5-HFCPE is 238° C. The GWP of 3,3,4,4,5,5-HFCPE is 33. The normal boiling point of 1,1,2,2,3,3-HFCPA is 88° C. The critical temperature of 1,1,2,2,3,3-HFCPA is 266° C. The GWP of 1,1,2,2,3,3-HFCPA is 125.

Specifically, the composition B2 is (E)-1,1,1,4,4,5,5,5-octafluoro-2-pentene (HFO-1438mzz(E), C₅H₂F₈), (Z)-1,1,1,4,4,5,5,5-octafluoro-2-pentene (HFO-1438mzz(Z), C₅H₂F₈), or the like. The normal boiling point of HFO-1438mzz(E) is 29.5° C.

The composition C contains 3 carbon atoms, 2 chlorine atoms, 3 fluorine atoms, and an intramolecular double bond. Specifically, the composition C is 1,2-dichloro-3,3,3-trifluoropropene (HCFO-1223xd(Z), C₃HCl₂F₃), or the like. The normal boiling point (boiling point at atmospheric pressure) of HCFO-1223xd(Z) is 54° C. The critical temperature of HCFO-1223xd(Z) is 222° C.

A refrigerant containing the composition A, the composition B, or the composition C is stable even under a high-temperature environment exceeding 150° C. A heat source machine in which such a refrigerant is enclosed in a heat pump cycle can be operated stably for a long period of time. Since the GWP of the composition A, the composition B, or the composition C is low, a heat source machine with a low environmental load can be realized.

A refrigerant may contain an additive. Examples of the additive include halocarbons, other hydrofluorocarbons (HFC), alcohols, and saturated hydrocarbons.

### <Halocarbons and Other Hydrofluorocarbons>

Examples of the halocarbons include methylene chloride containing a halogen atom, trichloroethylene, and tetrachloroethylene.

Examples of the hydrofluorocarbons include difluoromethane (HFC-32), 1,1,1,2,2-pentafluoroethane (HFC-125), fluoroethane (HFC-161), 1,1,2,2-tetrafluoroethane (HFC-134), 1,1,1,2-tetrafluoroethane (HFC-134a), 1,1,1-trifluoroethane (HFC-143a), difluoroethane (HFC-152a), 1,1,1,2,3,3,3-heptafluoropropane (HFC-227ea), 1,1,1,2,3-pentafluoropropane (HFC-236ea), 1,1,1,3,3,3-hexafluoropropane (HFC-236fa), 1,1,1,3,3-pentafluoropropane (HFC-245fa), 1,1,1,2,3-pentafluoropropane (HFC-245eb), 1,1,2,2,3-pentafluoropropane (HFC-245ca), 1,1,1,3,3-pentafluorobutane (HFC-365mfc), 1,1,1,3,3,3-hexafluoroisobutane (HFC-356mmz), and 1,1,1,2,2,3,4,5,5,5-decafluoropentane (HFC-43-10-mee).

### <Alcohol>

Examples of the alcohol include methanol, ethanol, n-propanol, i-propanol, n-butanol, i-butanol, 2,2,2-trifluoroethanol, pentafluoropropanol, tetrafluoropropanol, and 1,1,1,3,3,3-hexafluoro-2-propanol, each of which has 1 to 4 carbon atoms.

### <Saturated Hydrocarbon>

As the saturated hydrocarbon, at least one or more compounds selected from the group consisting of propane, n-butane, i-butane, neopentane, n-pentane, i-pentane, cyclopentane, methyl cyclopentane, n-hexane, and cyclohexane, each of which has 3 or more to 8 or less carbon atoms, can be mixed. Among them, examples of the particularly preferred substance include neopentane, n-pentane, i-pentane, cyclopentane, methyl cyclopentane, n-hexane, and cyclohexane.

### <Thermal Stability>

A test for the thermal stability was carried out by a method in accordance with JIS K 2211.

### (Test 1)

A test container was decompressed to vacuum, about 14 g of a test refrigerant was placed in the test container, and the test container was sealed. The inside of the sealed test container was heated at a predetermined temperature for 18 hours. The purity of each of the test refrigerants before and after heating was measured and the thermal stability was evaluated. The test refrigerant after heating was stored for two months under the atmosphere, and the changes in color was visually checked.

As the test refrigerant, 3,3,4,4,5,5-HFCPE was used. As the test container, a tube (having an internal volume of about 20 mL) made of stainless steel (SUS 316) was used. For the measurement of the purity, a gas chromatograph (2014S manufactured by Shimadzu Corporation) equipped with a flame ionization detector (FID) was used.

Test conditions and results of the purity measurement are shown in Table 1.

TABLE 1

Purity (GC area %)

| Temperature (° C.) | Before heating | After heating |
|---|---|---|
| 200 | 99.1 | 99.1 |
| 220 | 99.1 | 99.1 |
| 240 | 99.1 | 99.1 |
| 260 | 99.1 | 99.1 |
| 280 | 99.1 | 99.1 |
| 300 | 99.1 | 99.1 |

As shown in Table 1, the purity of the test refrigerant did not change before and after heating. Consequently, it was confirmed that 3,3,4,4,5,5-HFCPE is stable in the temperature range of 200° C. to 300° C. The test refrigerant heated at 200° C. and 220° C. did not change in color even after the storage under the atmosphere.

### (Test 2)

As the test refrigerant, HFO-1438mzz(E) mixed with HFO-1438mzz(Z) was used. As the test container, a test container similar to that in the above (Test 1) was used.

The test container was decompressed to vacuum, about 2 g of the test refrigerant was placed in the test container, and the test container was sealed. The inside of the sealed test container was heated at 250° C. for 72 hours. The purity of each of the test refrigerants before and after heating was measured and the thermal stability was evaluated. For the measurement of the purity, a gas chromatograph was used similarly as in the above (Test 1). The pH of each of the test refrigerants before and after heating was checked using pH test paper.

Results of the purity measurement of test 2 are shown in Table 2.

TABLE 2

Purity
(GC area %)

| Test refrigerant component | Before heating | After heating |
|---|---|---|
| Refrigerant composition B5 | 95.7 | 95.5 |
| Refrigerant composition B6 | 4.1 | 4.2 |

As shown in Table 2, the purity of the test refrigerants hardly changed before and after heating. Consequently, it was confirmed that HFO-1438mzz(E) and HFO-1438mzz(Z) were stable at 250° C. The pH in any case of the test refrigerants before and after heating was about pH 7. Consequently, it was confirmed that acid generation by heating was able to be suppressed.

### (Comparison Test)

Using HFO-1233zd(E) (boiling point of 18.3° C. and critical temperature of 165.6° C.) as a reference refrigerant, a test to confirm the thermal stability was carried out. As the test container, a test container similar to that in the above (Test 1) was used. As a catalyst, rod-shaped iron, copper, and aluminum were used.

The reference refrigerant and the catalyst were placed in the test container, and the test container was sealed. The inside of the sealed test container was vacuum-degassed while sufficiently being cooled with liquid nitrogen, and then heated at a predetermined temperature for 14 days. The purity of each of the reference refrigerants before and after heating was measured, and the thermal stability was evaluated. For the measurement of the purity, a gas chromatograph was used similarly as in the above (Test 1). The change in color of the reference refrigerant after heating was visually checked.

Test conditions and results of the purity measurement are shown in Table 3.

TABLE 3

| | |
|---|---|
| | Purity |
| Temperature | (GC area %) |

| (° C.) | Before heating | After heating |
|---|---|---|
| 150 | 99.99 | 99.05 |
| 175 | 99.99 | 98.04 |
| 187 | 99.99 | 90.58 |
| 200 | 99.99 | 91.67 |
| 225 | 99.99 | 90.03 |

As shown in Table 3, the purity of the reference refrigerant was decreased by heating. In particular, the deterioration of purity was remarkable in the temperature range of 187° C. or more. The color of the reference refrigerant after heating at 225° C. changed from the color of the reference refrigerant before heating.

### REFERENCE SIGNS LIST

1 Heat source machine
2 Centrifugal compressor
2A Suction opening
2B Discharge opening
2C Intermediate discharge opening
3 High-temperature condenser
4 Medium-temperature condenser
5 High-pressure stage expansion valve
6 Rotating shaft
7 Evaporator
8 Heat pump cycle (refrigerant circulation circuit)
9 Electric motor
10 High-temperature heat medium circuit
11 Low-pressure stage expansion valve
12 Intermediate discharge circuit
13 Heat source water circuit
14 High-temperature heat medium pump
15 Heat source water pump

1-7. (canceled)

8. A heat source machine, comprising:
a centrifugal compressor for compressing a refrigerant;
a condenser for condensing the compressed refrigerant;
an expansion valve for expanding the condensed refrigerant; and
an evaporator for evaporating the expanded refrigerant,
wherein a refrigerant enclosed in a refrigerant circulation circuit configured by sequentially connecting the centrifugal compressor, the condenser, the expansion valve, and the evaporator contains a composition A, a composition B, or a composition C,
the composition A has 4 or 5 carbon atoms, 6 or more fluorine atoms, and one or more oxygen atoms,
the composition B has 4 or 5 carbon atoms and 6 or more fluorine atoms,
the composition C has 3 carbon atoms, 2 chlorine atoms, 3 fluorine atoms, and an intramolecular double bond,
the composition A, the composition B, or the composition C has a boiling point of 20° C. or more and a critical temperature of 180° C. or more, and
the evaporator is configured to recover heat, and the condenser is configured to output thermal energy with 150° C. or more by the recovered heat.

9. The heat source machine according to claim 8, wherein the composition A is a composition containing 6 fluorine atoms and a methoxy group.

10. The heat source machine according to claim 8, wherein the composition B is a composition containing 6 fluorine atoms and a cyclic structure having 5 carbon atoms, or a composition containing 8 fluorine atoms, 5 carbon atoms, and an intramolecular double bond.

11. The heat source machine according to claim 9, wherein the composition A is 2,2,2,2′,2′,2′-hexafluoroisopropyl-methyl-ether.

12. The heat source machine according to claim 10, wherein the composition B is 3,3,4,4,5,5-hexafluorocyclopentene, 1,1,2,2,3,3-hexafluorocyclopentane, (E)-1,1,1,4,4,5,5,5-octafluoro-2-pentene, or (Z)-1,1,1,4,4,5,5,5-octafluoro-2-pentene.

13. The heat source machine according to claim 8, wherein the composition C is 1,2-dichloro-3,3,3-trifluoropropene.

14. A method for operating a heat source machine,
wherein the heat source machine comprises:
a centrifugal compressor for compressing a refrigerant;
a condenser for condensing the compressed refrigerant;
an expansion valve for expanding the condensed refrigerant;
an evaporator for evaporating the expanded refrigerant;
and a refrigerant circulation circuit configured by sequentially connecting the centrifugal compressor, the condenser, the expansion valve, and the evaporator,
the refrigerant is selected from any one of: a composition A having 4 or 5 carbon atoms, 6 or more fluorine atoms, and one or more oxygen atoms; a composition B having 4 or 5 carbon atoms and 6 or more fluorine atoms; and a composition C having 3 carbon atoms, 2 chlorine atoms, 3 fluorine atoms, and an intramolecular double bond, and is enclosed in the refrigerant circulation circuit, the composition A, the composition B, or the composition C having a boiling point of 20° C. or more and a critical temperature of 180° C. or more, and
heat is recovered in the evaporator, and thermal energy with 150° C. or more is output by the recovered heat in the condenser.
